(19) United States
(12) Patent Application Publication
(10) Pub. No.: US 2006/0289767 A1
(43) Pub. Date: Dec. 28, 2006

(54) Reflective mirror structure

(75) Inventor: Ting-Hua Lung, Taoyuan County (TW)

Correspondence Address: BIRCH STEWART KOLASCH & BIRCH, PO BOX 747, FALLS CHURCH, VA, 22040-0747, US

(73) Assignee: EVERSPRING INDUSTRY CO., LTD.

(21) Appl. No.: 11/150,245

(22) Filed: Jun. 13, 2005

(51) Int. Cl. G01J 5/02

(52) U.S. Cl. 250/353

(57) ABSTRACT

The invention discloses an improved reflective mirror structure used together with a sensor, and the reflective mirror includes at least one elliptic curved surface, and the elliptic curved surface has a first focus and a second focus, and the sensing area of the sensor is located at the second focus. With the characteristic of having dual foci on the elliptic curved surface, the light beams incident from different directions are passed through the first focus of the elliptic curved surface and then reflected from the elliptic curved surface towards the second focus and received by the sensor, and such design makes the detecting range of the sensor larger than 180 degrees.

### FIELD OF THE INVENTION

The present invention relates to an improved reflective mirror structure, and more particularly to an improved reflective mirror structure that increases the detecting range of a sensor.

### BACKGROUND OF THE INVENTION

The mostly used electronic device for detecting human bodies adopts a pyroelectric infrared sensor, and its characteristics are used for different applications, particularly the one used as a component for burglar alarms. If the sensor detects a change of energy distribution, the sensor will produce a signal to turn on a light or activate a siren to achieve the burglarproof effect.

At present, a vast majority of products using passive infrared (PIR) to detect human bodies adopts a lens array made of a high density polyethylene (HDPE) material to focus the infrared emitted from a human body, and the focused infrared is reflected to a sensing area of a sensor by a reflective mirror.

U.S. Pat. No. 5,103,346 entitled “Detector with 180 detecting range” discloses a signal deflector having several reflective planes, and such signal deflector has the shortcoming of a very limited detecting range. Since the angle of incidence varies, therefore it is necessary to compute the position of a reflective point.

U.S. Pat. No. 6,653,635 provides a “Detector with wide detecting range” and discloses a reflective mirror having a plurality of symmetric reflective units, and the incident infrared ray is focused by a lens with a single focal length, and each path of the infrared rays includes S3, S4, S5 and S6, but these infrared rays are incident from the point Es. Although the reflective mirror can solve the issue of the angle of incidence, yet the centralized energy of the focused infrared cannot be maximized.

### SUMMARY OF THE INVENTION

The primary objective of the present invention is to provide an improved reflective mirror structure used together with a sensor for increasing the detecting range of the sensor.

To achieve the foregoing objective, the present invention provides an improved reflective mirror structure, and the reflective mirror is used for reflecting light beams incident from different directions to a sensor, wherein the sensor has at least one elliptic curved surface, and the elliptic curved surface has a first focus and a second focus, and the sensing area of the sensor is located at the second focus. After the light beams incident from different directions pass through the first focus of the elliptic curved surface, the light beams are reflected from the elliptic curved surface to the second focus and received by the sensor, and the detecting range of the sensor can exceed 180 degrees.

### BRIEF DESCRIPTION OF THE DRAWINGS

FIG. 1 PRIOR ART is a schematic view of a major axis, a minor axis and a focal length of an ellipse according to a prior art;

FIG. 2 PRIOR ART is a schematic view of a path of a light passing through the two foci of an ellipse according to a prior art;

FIG. 3 is a perspective view of a reflective mirror having a single elliptic curved surface together with a sensor according to the present invention;

FIG. 4 is side view of a reflective mirror having a single elliptic curved surface together with a sensor according to the present invention; and

FIG. 5 is a perspective view of a reflective mirror having a plurality of elliptic curved surfaces together with a sensor according to the present invention.

### DETAILED DESCRIPTION OF THE PREFERRED EMBODIMENTS

The technical contents of the present invention will now be described in more detail hereinafter with reference to the accompanying drawings that show various embodiments of the invention.

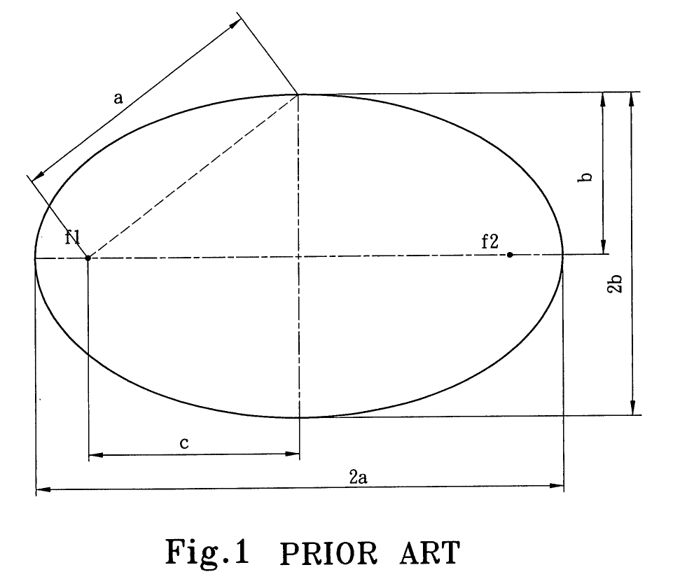

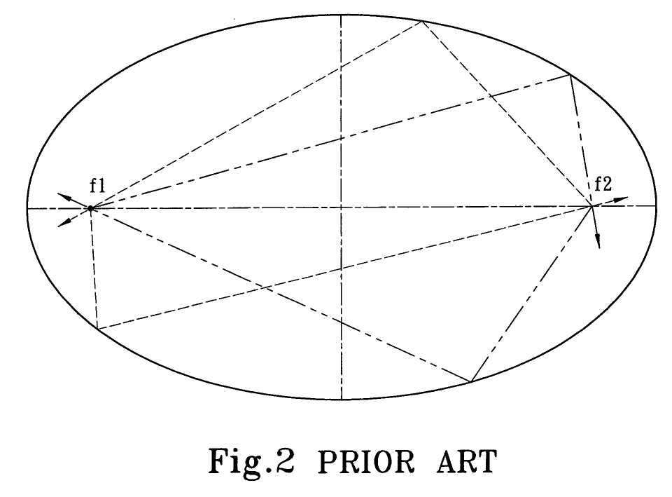

Referring to FIG. 1 PRIOR ART and FIG. 2 PRIOR ART, the shape of an ellipse depends on the length of a major axis 2a, a minor axis 2b and the focal length c, and these variables are related by a formula c2+b2=a2. It is noteworthy that an ellipse has two foci f1, f2. After a light beam or a sound wave sent out from a focus is reflected, the light beam must pass through another focus. Therefore, if there is an energy collecting system collects the energy at the first focus, the energy also can be collected at another focus after being reflected. This characteristic can be used on a passive infrared (PIR) sensor, and the range not covered by the PIR sensor is reflected by the reflective mirror of the invention, such that the infrared ray produced by human bodies is reflected to the detecting range of the PIR sensor.

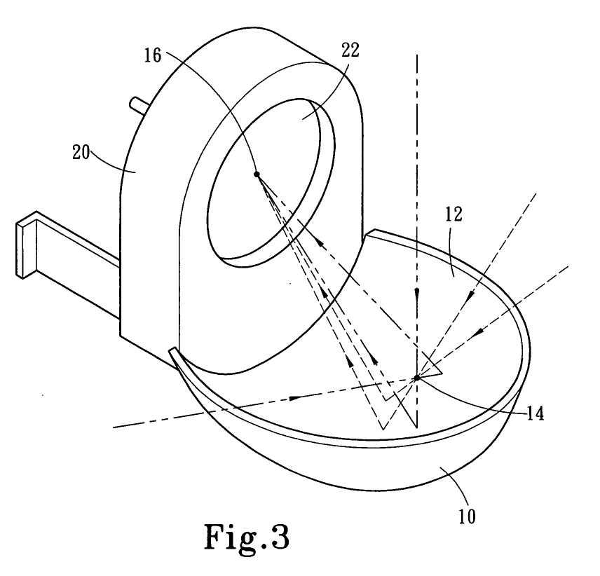

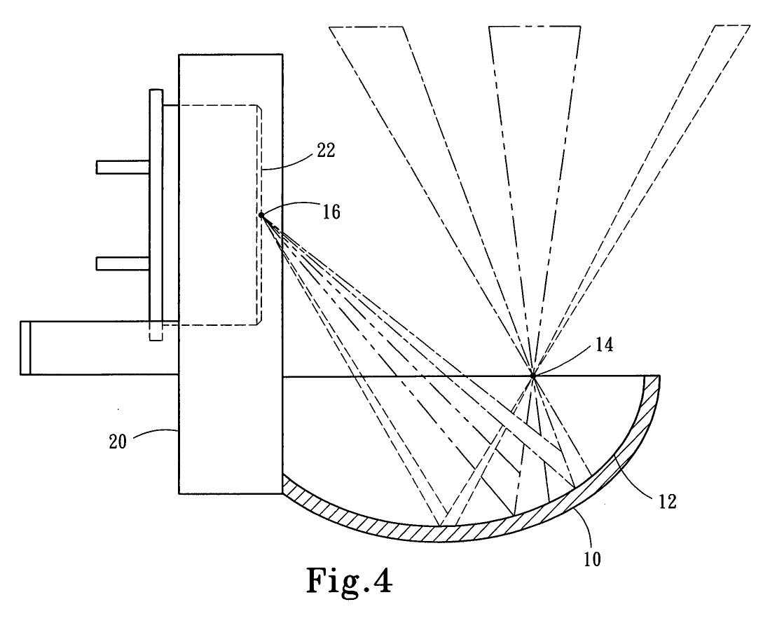

Referring to FIGS. 3 and 4 for a preferred embodiment of the present invention, a reflective mirror 10 is used together with a sensor 20 such as a pyroelectric infrared sensor for reflecting light beams or infrared rays incident from different directions onto a sensing area 22 of the sensor 20. The reflective mirror 10 has an elliptic curved surface 12, and the elliptic curved surface 12 includes a first focus 14 and a second focus 16, and the sensing area 22 of the foregoing sensor 20 is located on the second focus 16. With the characteristic of dual foci of the elliptic curved surface 12 of the reflective mirror 10, the light beams incident from different directions are passed through the first focus 14 of the elliptic curved surface 12 and then reflected from the elliptic curved surface towards the second focus 16, and then received by the sensing area 22 of the sensor 20. Therefore, the detecting range of the sensor 20 can exceed 180 degrees.

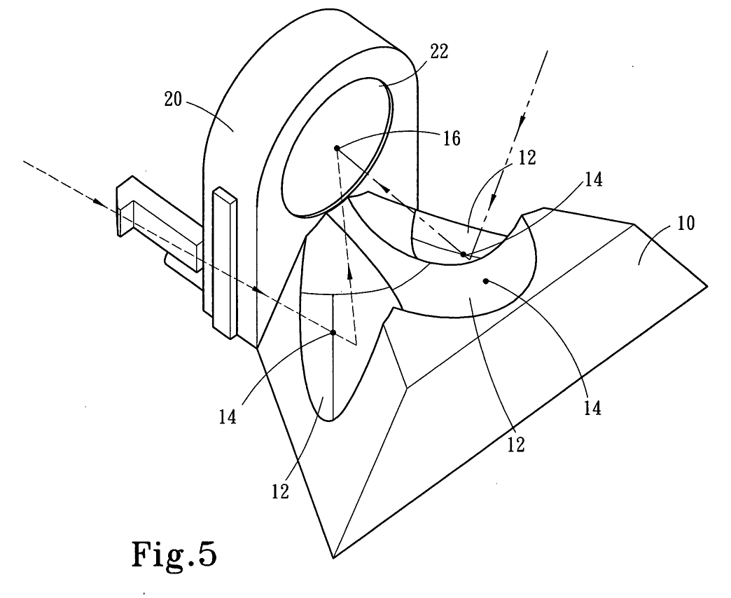

Referring to FIG. 5 for a preferred embodiment of the present invention, the reflective mirror 10 includes a plurality of elliptic curved surfaces 12, and each of these elliptic curved surfaces 12 includes a first focus 14 and a second focus 16, and the sensing area 22 of the foregoing sensor 20 is located at the second focus 16. Similarly, the light beams incident from different directions are passed through the first focus 14 of each elliptic curved surface and then reflected from these elliptic curved surfaces 12 towards the common second focus 16 and received by the sensing area 22 of the sensor 20. In other words, if the reflective mirror 10 has a plurality of elliptic curved surfaces, the second focus 16 of these elliptic curved surfaces 12 are designed to be overlapped at a point.

In summation of the description above, the improved reflective mirror structure of the present invention has the following advantages:
1. When the elliptic curved surface of the reflective mirror is used for detecting human bodies by infrared rays, the detecting range can cover the front side, bottom side, left and right sides, and the left and right sides of the rear of the sensor, and thus its detecting range exceeds 180 degrees.
2. Since the reflective mirror includes an elliptic curved surface and a designer needs not to compute the position of a reflective point but just needs to focus on one of the foci, therefore the designing time can be saved.
3. Since the elliptic curved surface of the reflective mirror is adopted, the required radius of curvature can be calculated from each angle or each point for the optimization, even though the angles of incidence are different.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An improved reflective mirror structure, used for reflecting light beams incident from different directions onto a sensor for increasing the detecting range of said sensor, characterized in that said reflective mirror comprises at least one elliptic curved surface, and said elliptic curved surface includes a first focus and a second focus, and a sensing area of said sensor is situated at said second focus, and said light beams incident from different directions are passed through said first focus and reflected from said elliptic curved surface towards said second focus and received by said sensor.

2. The improved reflective mirror structure of claim 1, wherein said incident light beam is an infrared ray, and said sensor is a pyroelectric infrared sensor.

3. The improved reflective mirror structure of claim 1, wherein said second focus of said elliptic curved surfaces is overlapped at a point, if said reflective mirror has a plurality of elliptic curved surfaces.
